(19) United States
(12) Patent Application Publication
(10) Pub. No.: US 2025/0124727 A1
(43) Pub. Date: Apr. 17, 2025

(54) AVATAR GENERATION APPARATUS

(71) Applicant: NTT DOCOMO, INC., Tokyo (JP)

(72) Inventors: Tomohito YAMASAKI, Chiyoda-ku (JP); Youhei FUJIMOTO, Chiyoda-ku (JP); Ichitaro TSUKADA, Chiyoda-ku (JP)

(73) Assignee: NTT DOCOMO, INC., Tokyo (JP)

(21) Appl. No.: 18/716,767

(22) PCT Filed: Dec. 19, 2022
(86) PCT No.: PCT/JP2022/046662

§ 371 Date: Dec. 18, 2024

(30) Foreign Application Priority Data
Dec. 23, 2021 (JP) 2021-209149

(51) Int. Cl. G06V 20/64; G06T 7/579; G06T 19/00; G06V 10/774; G06V 40/16; G06V 40/20; G06V 40/40

(52) U.S. Cl. CPC G06V 20/64; G06T 7/579; G06T 19/00; G06V 10/774; G06V 40/172; G06V 40/20; G06V 40/40; G06T 2207/10016; G06T 2207/30201

(57) ABSTRACT

A server serving as an avatar generation apparatus includes: a first acquirer configured to acquire a first image indicating a front face portion of a user; a second acquirer configured to acquire, in response to a motion of the user's head, a second image indicating the front face portion and a side face portion of the user; an authenticator configured to authenticate the user based on the first and second images; and an image generator configured to generate a head image of a three-dimensional avatar of the user, by using the second image.

### TECHNICAL FIELD The present invention relates to avatar generation apparatuses.

### BACKGROUND ART

Occasionally, a character, called an avatar on the Internet, serves as a double of a user. In recent years, use of a technique of a three-dimensional (3D) scanning enables general use of a 3D image of an avatar indicating the appearance of a user in, especially, a 3D virtual space.

For example, Patent Document 1 discloses a virtual fitting apparatus that uses a 3D image avatar. The virtual fitting apparatus receives a head image of a model, figure information relating to the model, clothes of an identical portion of a body, and the order in which the clothes are worn. Furthermore, the virtual fitting apparatus extracts two-dimensional (2D) images that correspond to the clothes from an image information database obtained by converting wearing states of clothes into 2D images. The virtual fitting apparatus generates a composite image obtained by combining the 2D images based on the order in which the clothes are worn. The virtual fitting apparatus converts the composite image into a 3D image based on the figure information. The virtual fitting apparatus transmits the 3D image and the head image to a terminal apparatus. An example of the “head image” is a 3D image obtained by performing 3D scanning by using a user's terminal apparatus.

### RELATED ART DOCUMENT

### Patent Document

Patent Document 1: WO 2020/009066

### SUMMARY OF THE INVENTION

### Problem to be Solved by the Invention

However, in the technique of Patent Document 1, a user who uses the terminal apparatus can input, to the virtual fitting apparatus, a head image that differs from a head image of the user, to impersonate another person. In such an act of impersonation, a malicious person might unjustly damage the reputation of an individual.

In view of the above, a problem to be solved by the present invention is to generate a 3D avatar, for which the identity of a user has been verified, to avoid an act of impersonation.

### Means for Solving the Problems

An avatar generation apparatus in a preferred aspect of the present invention is an avatar generation apparatus including: a first acquirer configured to acquire a first image indicating a front face portion of a user; a second acquirer configured to acquire, in response to a motion of the user's head, a second image indicating the front face portion and a side face portion of the user; an authenticator configured to authenticate the user based on the first and second images; and an image generator configured to generate a head image of a three-dimensional avatar of the user, by using the second image.

### Effect of the Invention

According to the present invention, a 3D avatar, for which the identity of a user has been verified, is generated, and therefore, an act of impersonation is avoided.

### BRIEF DESCRIPTION OF THE DRAWINGS

FIG. 1 is a diagram illustrating an overall configuration of an information processing system 1 according to a first embodiment.

FIG. 2 is a perspective view illustrating an external appearance of MR glasses 30 according to the first embodiment.

FIG. 3 is a schematic diagram of a virtual space VS that is provided to a user U1 by using the MR glasses 30 according to the first embodiment.

FIG. 4 is a schematic diagram of a virtual space VS that is provided to the user U1 by using the MR glasses 30 according to the first embodiment.

FIG. 5 is a block diagram illustrating an example of a configuration of the MR glasses 30 according to the first embodiment.

FIG. 6 is a block diagram illustrating an example of a configuration of a terminal apparatus 20 according to the first embodiment.

FIG. 7 is a flow of generating a 3D image WP of an overall avatar A1 according to the first embodiment.

FIG. 8 is a block diagram illustrating an example of a configuration of a server 10 according to the first embodiment.

FIG. 9 is a flowchart illustrating an operation of the server 10 according to the first embodiment.

FIG. 10 is a block diagram illustrating an example of a configuration of a server 10A according to a second embodiment.

FIG. 11 is a block diagram illustrating an example of a configuration of a server 10B according to a third embodiment.

### MODES FOR CARRYING OUT THE INVENTION

### 1: First Embodiment

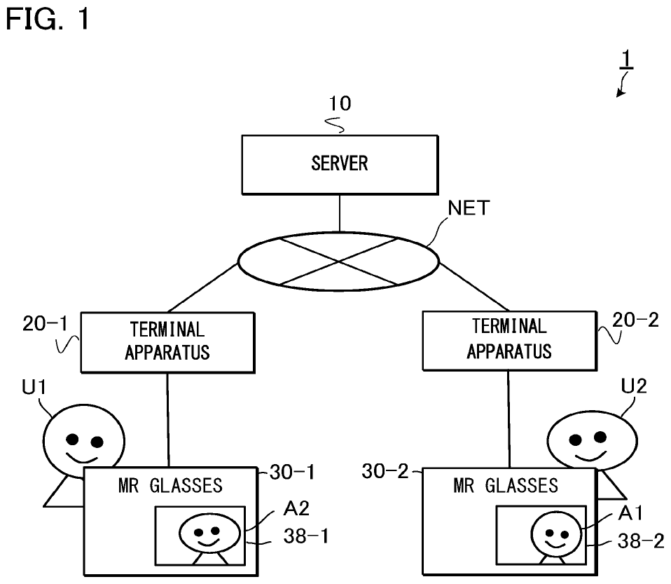

With reference to FIGS. 1 to 9, description will be given of a configuration of an information processing system 1 including a server 10. The server 10 serves as an avatar generation apparatus according to a first embodiment of the present invention.

### 1-1: Configuration According to First Embodiment

### 1-1-1: Overall Configuration

FIG. 1 is a diagram illustrating an overall configuration of the information processing system 1 according to the first embodiment of the present invention. The information processing system 1 using an MR technique provides a virtual space to a user U1 and a user U2 wearing a pair of MR glasses 30. In particular, in the present embodiment, the information processing system 1 causes the MR glasses 30 to display an avatar A1 that corresponds to the user U1, and an avatar A2 that corresponds to the user U2. The MR technique is used to precisely superimpose a digital virtual space onto a real space, by using XR glasses (e.g., the MR glasses 30), or a device such as a head mounted display (HMD). The MR technique enables the user U1 and the user U2 to simultaneously experience two spaces: a real space in which a real object is disposed, and a virtual space in which a virtual object is disposed.

The information processing system 1 includes the server 10, a terminal apparatus 20, and the MR glasses 30. The server 10 is an example of the avatar generation apparatus. In the information processing system 1, the server 10 and the terminal apparatus 20 are communicably connected to each other via a communication network NET. The terminal apparatus 20 and the MR glasses 30 are communicably connected to each other. In FIG. 1, as a pair of the terminal apparatus 20 and the MR glasses 30, two pairs in total are illustrated: (i) a pair of a terminal apparatus 20-1 and MR glasses 30-1 and (ii) a pair of a terminal apparatus 20-2 and MR glasses 30-2. However, this number of pairs is only an example, and the information processing system 1 may include a freely chosen number of pairs of the terminal apparatus 20 and the MR glasses 30. In FIG. 1, it is envisaged that the user U1 uses the pair of the terminal apparatus 20-1 and the MR glasses 30-1, and the user U2 uses the pair of the terminal apparatus 20-2 and the MR glasses 30-2.

The server 10 provides a variety of types of data and a cloud service to the terminal apparatus 20 via the communication network NET. In particular, the server 10 provides the terminal apparatus 20 with a variety of types of data used to display on the MR glasses 30 connected to the terminal apparatus 20, the avatar A1 that corresponds to the user U1, and the avatar A2 that corresponds to the user U2. More specifically, the server 10 provides the terminal apparatus 20-1 with a variety of types of data for displaying the avatar A2 on a display 38-1. The display 38-1 is included in the MR glasses 30-1 that the user U1 uses. The server 10 provides the terminal apparatus 20-2 with various types of data for causing a display 38-2 to display the avatar A1. The display 38-2 is included in the MR glasses 30-2 that the user U2 uses. In the present embodiment, the avatar A1 is a realistic avatar that has been generated by using a captured image of the user U1. Similarly, the avatar A2 is a realistic avatar that has been generated by using an actually captured image of the user U2.

The terminal apparatus 20-1 causes the MR glasses 30-1 worn on the head of the user U1 to display a virtual object to be disposed in the virtual space. The terminal apparatus 20-2 causes the MR glasses 30-2 worn on the head of the user U2 to display a virtual object to be disposed in the virtual space. The virtual space is, as an example, a dome-shaped space. Examples of the virtual object include (i) a virtual object represented by a still image, a video, a 3D CG model, an HTML file, a text file, and (ii) a virtual object represented by an application software. Here, examples of the text file include a memorandum, a source code, a diary, and a recipe. Examples of the application software include a browser application, a SNS application, and an application software for a document file. It is preferable that the terminal apparatus 20-1 be a portable terminal apparatus, such as a smartphone or a tablet.

In particular, in the present embodiment, the terminal apparatus 20-1 causes the MR glasses 30-1 to display a virtual object that corresponds to the avatar A2. The terminal apparatus 20-2 causes the MR glasses 30-2 to display a virtual object that corresponds to the avatar A1.

The MR glasses 30 are a display apparatus that is mounted on the heads of the user U1 and the user U2. More specifically, the MR glasses 30-I are a display apparatus that is mounted on the head of the user U1. The MR glasses 30-2 are a display apparatus that is mounted on the head of the user U2. The MR glasses 30 are a see-through wearable display. The MR glasses 30 are controlled by the terminal apparatus 20 to display a virtual object on a display panel provided corresponding to each of the lenses for both eyes. The MR glasses 30 are an example of a display apparatus.

### 1-1-2: Configuration of MR Glasses

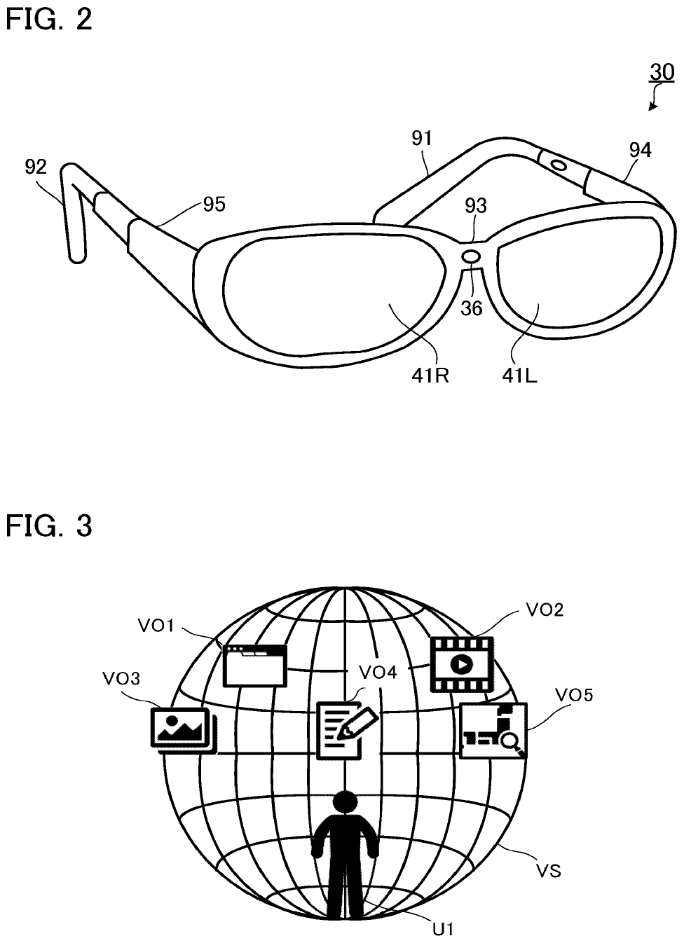

FIG. 2 is a perspective view illustrating an external appearance of the MR glasses 30. As illustrated in FIG. 2, the external appearance of the MR glasses 30 is substantially the same as an external appearance of a pair of ordinary eyeglasses, and includes temples 91 and 92, a bridge 93, frames 94 and 95, and lenses 41L and 41R. The bridge 93 is provided with an image capture device 36. The image capture device 36 captures an image of an outside world. The image capture device 36 outputs image capture information indicating a captured image.

Each of the lenses 41L and 41R includes a half mirror. The frame 94 is provided with a liquid crystal panel or an organic EL panel for the left eye. Hereinafter, the liquid crystal panel or the organic EL panel is referred to as a display panel. The frame 94 is provided with an optical member that guides, to the lens 41L, light emitted from the display panel for the left eye. The half mirror provided in the lens 41L transmits light of the outside world, and guides the light to the left eye. The half mirror also reflects the light that has been guided by the optical member, and makes the light incident on the left eye. The frame 95 is provided with a display panel for the right eye, and an optical member that guides, to the lens 41R, light emitted from the display panel for the right eye. The half mirror that is provided in the lens 41R transmits light of the outside world, and guides the light to the right eye. The half mirror also reflects the light that has been guided by the optical member, and makes the light incident on the right eye.

The display 38 (described later) includes the lens 41L, the display panel for the left eye, and the optical member for the left eye, and the lens 41R, the display panel for the right eye, and the optical member for the right eye.

By employing the configuration, the users U1 and U2 can see an image shown by the display panel in a see-through state in which the image has been superimposed onto the outside world. The MR glasses 30 cause the display panel for the left eye to display an image for the left eye within images for both eyes involving parallax, and cause the display panel for the right eye to display an image for the right eye. This enables the user U1 and the user U2 to perceive a displayed image as if the displayed image has depth and a stereoscopic effect.

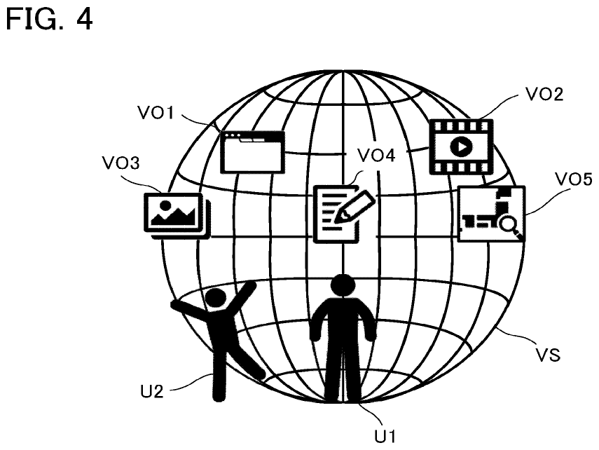

FIGS. 3 and 4 are each a schematic diagram of a virtual space VS provided to the users U1 and U2 by using the MR glasses 30. As illustrated in FIG. 3, the following are disposed in the virtual space VS: a virtual object VO1 to a virtual object VO5 that indicate a variety of pieces of content, such as a browser, a cloud service, an image, or a video. The user U1, who is wearing the MR glasses 30 displaying the virtual objects VO1 to VO5 disposed in the virtual space VS, comes and goes in a public space. As a result, the user U1 can experience the virtual space VS serving as a private space in the public space. The user U1 also can act in the public space while gaining benefits derived from the virtual objects VO1 to VO5 disposed on the virtual space VS. The same is applied to the user U2.

As illustrated in FIG. 4, the users U1 and U2 can share the virtual space VS. Sharing the virtual space VS with the users U1 and U2 allows for the users U1 and U2 to share one or more virtual objects VO and to interact with each other through the shared virtual object VO.

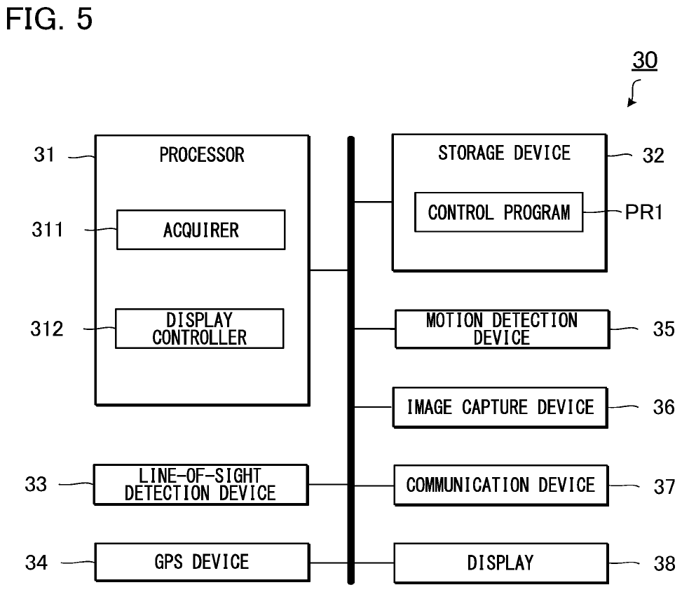

FIG. 5 is a block diagram illustrating an example of a configuration of the MR glasses 30. The MR glasses 30 include a processor 31, a storage device 32, a line-of-sight detection device 33, a GPS device 34, a motion detection device 35, the image capture device 36, a communication device 37, and the display 38. Elements included in the MR glasses 30 are connected to each other by a single bus or by multiple buses for communication. The term “device” herein may be replaced with another term, such as “circuit” or “unit”. Description will be given below of two scenarios, in one of which the MR glasses 30 are used by the user U1, and in the other of which the MR glasses 30 are the MR glasses 30-1.

The processor 31 controls the entirety of the MR glasses 30. The processor 31 comprises one or more chips, such as a central processing unit (CPU) including an interface with a peripheral device, an arithmetic device, and a register. One, some, or all of the functions of the processor 31 may be implemented by hardware, such as a digital signal processor (DSP), an application specific integrated circuit (ASIC), a programmable logic device (PLD), or a field programmable gate array (FPGA). The processor 31 performs a variety of types of processing in parallel or sequentially.

The storage device 32 is a recording medium that is readable and writable by the processor 31. The storage device 32 stores programs including a control program PR1 executed by the processor 31.

The line-of-sight detection device 33 detects a line of sight of the user U1. The line-of-sight detection device 33 may use any method to detect a line of sight. The line-of-sight detection device 33 may detect line-of-sight information based on positions of the inner corners of the eyes and positions of the irises. The line-of-sight detection device 33 supplies the processor 31 (described later) with line-of-sight information indicating a direction of the line of sight of the user U1, based on a result of detection. The line-of-sight information supplied to the processor 31 is transmitted to the terminal apparatus 20 via the communication device 37.

The GPS device 34 receives radio waves from two or more satellites. The GPS device 34 generates positional information from the received radio waves. The positional information indicates a position of the MR glasses 30. The positional information may be of any format as long as the position is identified. For example, the positional information indicates the latitude and longitude of the MR glasses 30, and it is acquired from the GPS device 34. However, the MR glasses 30 may acquire the positional information by using any method. The acquired positional information is supplied to the processor 31. The positional information supplied to the processor 31 is transmitted to the terminal apparatus 20 via the communication device 37.

The motion detection device 35 detects a motion of the MR glasses 30. Examples of the motion detection device 35 include an inertial sensor, such as an acceleration sensor that detects acceleration, or a gyro sensor that detects angular acceleration. The acceleration sensor measures accelerations on an X-axis, a Y-axis, and a Z-axis that are orthogonal to each other. The gyro sensor measures angular accelerations with the X-axis, the Y-axis, and the Z-axis as a central axis of rotation. The motion detection device 35 generates motion information indicating the motion of the MR glasses 30 based on information output by the gyro sensor. The motion information includes acceleration data indicating each of the accelerations on three axes, and angular acceleration data indicating each of the angular accelerations of the three axes. The motion detection device 35 supplies the processor 31 with motion information relating to the motion of the MR glasses 30. The motion information supplied to the processor 31 is transmitted to the terminal apparatus 20 via the communication device 37.

The image capture device 36 outputs image capture information obtained by imaging the outside world. The image capture device 36 includes a lens, an image capture element, an amplifier, and an AD converter. Light focused by using the lens is converted into an image capture signal (an analog signal) by the image capture element. The amplifier amplifies the image capture signal, and supplies the image capture signal to the AD converter. The AD converter converts the amplified image capture signal (an analog signal) into image capture information (a digital signal). The converted image capture signal is supplied to a processor 21. The image capture information supplied to the processor 31 is transmitted to the terminal apparatus 20 via the communication device 37.

The communication device 37 is hardware serving as a transmission/reception device that performs communication with another apparatus. The communication device 37 is also referred to as a network device, a network controller, a network card, a communication module. The communication device 37 may include a connector for wired connection, and it may include an interface circuit that corresponds to the connector. The communication device 37 may include a wireless communication interface. Examples of the connector for wired connection and the interface circuit include products conforming to a wired LAN, IEEE 1394, and USB. Examples of the wireless communication interface include products conforming to a wireless LAN, Bluetooth (registered trademark), and the like.

The display 38 is a device that displays images. The display 38 displays a variety of images under the control of the processor 31. The display 38 includes the lens 41L, the display panel for the left eye, and the optical member for the left eye, and the lens 41R, the display panel for the right eye, and the optical member for the right eye, as described above. As the display panel, a variety of display panels, such as a liquid crystal display panel, or an organic EL display panel, are preferably used.

The processor 31 reads, for example, the control program PR1 from the storage device 32 and executes the control program PR1, and therefore, the processor 31 acts as an acquirer 311 and a display controller 312.

The acquirer 311 acquires from the terminal apparatus 20, image information indicating an image to be displayed on the MR glasses 30.

The acquirer 311 acquires the following information: the line-of-sight information supplied from the line-of-sight detection device 33, the positional information supplied from the GPS device 34, the motion information supplied from the motion detection device 35, and the image capture information supplied from the image capture device 36. The acquirer 311 then supplies the communication device 37 with the following information: the line-of-sight information, the positional information, the motion information, and the image capture information that have been acquired. The following information are transmitted to the terminal apparatus 20: the line-of-sight information, the positional information, the motion information, and the image capture information that have been supplied to the communication device 37.

The display controller 312 causes the display 38 to display an image indicated by the image information based on the image information acquired by the acquirer 311 from terminal apparatus 20.

### 1-1-3: Configuration of Terminal Apparatus

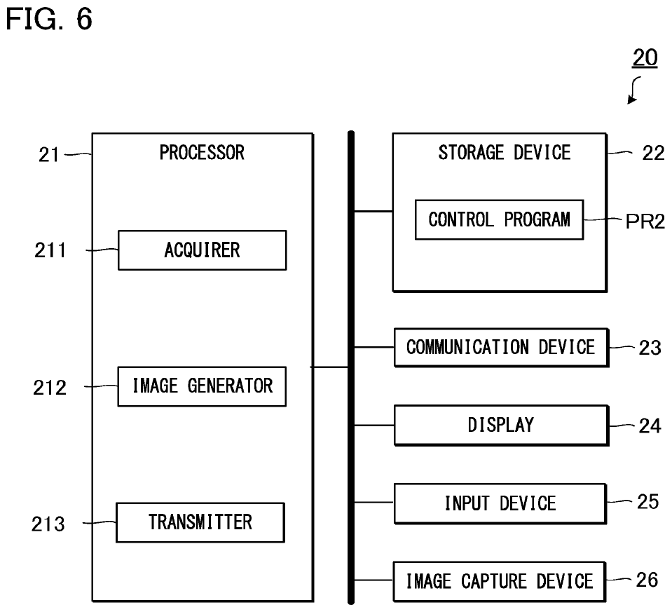

FIG. 6 is a block diagram illustrating an example of a configuration of the terminal apparatus 20. The terminal apparatus 20 includes the processor 21, a storage device 22, a communication device 23, a display 24, an input device 25, and an image capture device 26. Elements included in the terminal apparatus 20 are connected to each other by a single bus or by multiple buses for communication.

The processor 21 controls the entirety of the terminal apparatus 20. The processor 21 comprises one or more chips, such as a central processing unit (CPU) including an interface with a peripheral device, an arithmetic device, and a register. One, some, or all of the functions of the processor 21 may be implemented by hardware, such as a DSP, an ASIC, a PLD, or an FPGA. The processor 21 performs a variety of types of processing in parallel or sequentially.

The storage device 22 is a recording medium that is readable and writable by the processor 21. The storage device 22 stores programs including a control program PR2 that is executed by the processor 21.

The communication device 23 is hardware serving as a transmission and reception device that communicate with another apparatus. The communication device 23 is also referred to as a network device, a network controller, a network card, and a communication module. The communication device 23 may include a connector for wired connection, and it may include an interface circuit that corresponds to the connector. The communication device 23 may include a wireless communication interface. Examples of the connector for wired connection and the interface circuit include products conforming to a wired LAN, IEEE 1394, and USB. Examples of the wireless communication interface include products conforming to a wireless LAN, Bluetooth (registered trademark).

The display 24 displays an image and character information. The display 24 displays a variety of images under the control of the processor 21. As the display 24, a variety of display panels, such as a liquid crystal panel, or an organic electroluminescent (EL) display panel, are preferably used.

In particular, in the present embodiment, when the server 10 authenticates the user U1, the display 24 shows an image and character information that gives the user U1 instructions to move the head of the user U1.

The input device 25 receives an operational input from the user U1 wearing the MR glasses 30 on the head. The input device 25 includes a pointing device, such as a keyboard, a touch pad, a touch panel, and a mouse. If the input device 25 is a touch panel, the input device 25 may serve as the display 24.

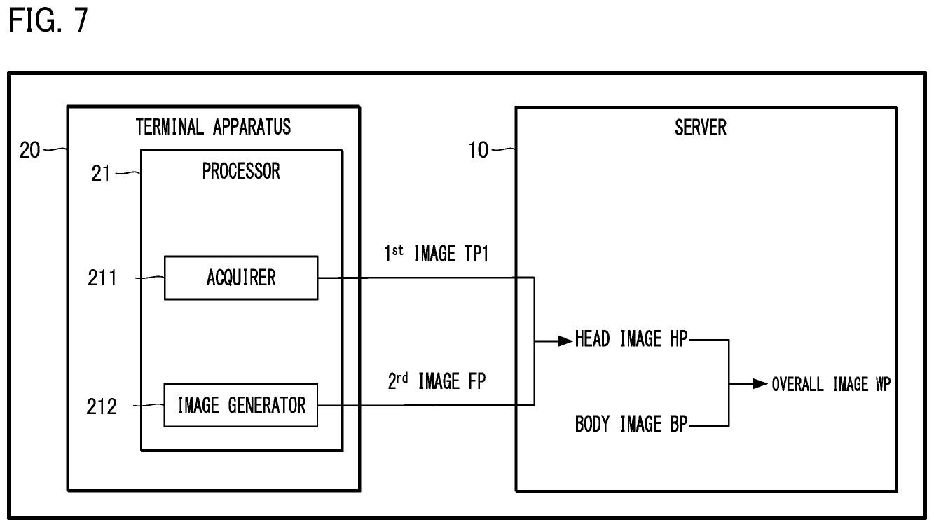

In the present embodiment, for the purpose of generating of a 3D realistic avatar, the user U1 uploads a first image TP1 of a front face portion of the user U1 to the server 10 from the terminal apparatus 20. The first image TP1 is a 2D image that is generated based on a photograph of the face of the user U1. However, the first image TP1 is not limited to the 2D image generated based on the photograph of the face of the user U1. FIG. 7 illustrates a flow of generating a 3D image WP of the overall avatar A1 serving as a realistic avatar of the user U1. As illustrated in FIG. 7, the first image TP1 is used for a head image HP of the avatar A1. At the time of uploading, the input device 25 is used by the user U1 to input the first image TP1 to the terminal apparatus 20. The first image TP1 may be an image of the user U1 captured by the image capture device 26 (described later), or it may be acquired from external equipment by using the communication device 23.

The image capture device 26 outputs image capture information obtained by imaging the outside world. The image capture device 26 includes a lens, an image capture element, an amplifier, and an AD converter. Light focused by using the lens is converted into an image capture signal (an analog signal) by the image capture element. The amplifier amplifies the image capture signal, and outputs the image capture signal to the AD converter. The AD converter converts the amplified image capture signal (an analog signal) into image capture information (a digital signal). The image capture signal after conversion is output to the processor 21. The image capture information output to the processor 21 is output to the server 10 via the communication device 23.

In the present embodiment, the user U1 needs to have the user authenticated by the server 10 at the time of generating the realistic avatar. At the time of authentication, the user U1 moves the head in accordance with an image and character information that give instructions to move the head of the user U1. The image and character information are shown on the display 24. When the head of the user U1 moves, the image capture device 26 captures an image of the head of the user U1. It is preferable that the image capture device 26 generate a video obtained by imaging the motion of the head of the user U1.

The processor 21 reads the control program PR2 from the storage device 22, and executes the control program PR2, and therefore, the processor 21 acts as an acquirer 211, an image generator 212, and a transmitter 213.

The acquirer 211 acquires a first image TP1 of the front face portion of the user U1. The acquirer 211 acquires from the server 10 via the communication device 23, image information indicating an image to be displayed on the MR glasses 30. The acquirer 211 acquires the following information from the MR glasses 30 via the communication device 23: the line-of-sight information, the positional information, the motion information, and the image capture information.

When the user U1 moves the head, an image of the head is captured by the image capture device 26. The image generator 212 generates a second image FP of the front face portion and the side face portion of the user U1 based on the captured image of the head of the user U1. Generally, the second image FP is a 3D image. However, the second image FP is not limited to the 3D image. For example, the second image FP may comprise two or more 2D images of the front face portion or the side face portion of the user U1. As illustrated in FIG. 7, the second image FP is used for the head image HP of the avatar A1 serving as a realistic avatar of the user U1.

The transmitter 213 transmits the following information to the server 10: image information indicating the first image TP1 of the front face portion of the user U1, the line-of-sight information, the positional information, the motion information, and the image capture information acquired by the acquirer 211. The transmitter 213 transmits to the server 10, the second image FP of the front face portion and the side face portion of the user U1, which is generated by the image generator 212.

The transmitter 213 transmits the image information acquired by the acquirer 211 to the MR glasses 30 such that the virtual object VO is to be shown in the virtual space VS based on the image information. The image information indicates an image of the virtual object VO. Specifically, the transmitter 213 transmits the image information to the MR glasses 30 such that the virtual object VO is to be shown in the virtual space VS viewed by the user U1 through the MR glasses 30.

### 1-1-4: Configuration of Server

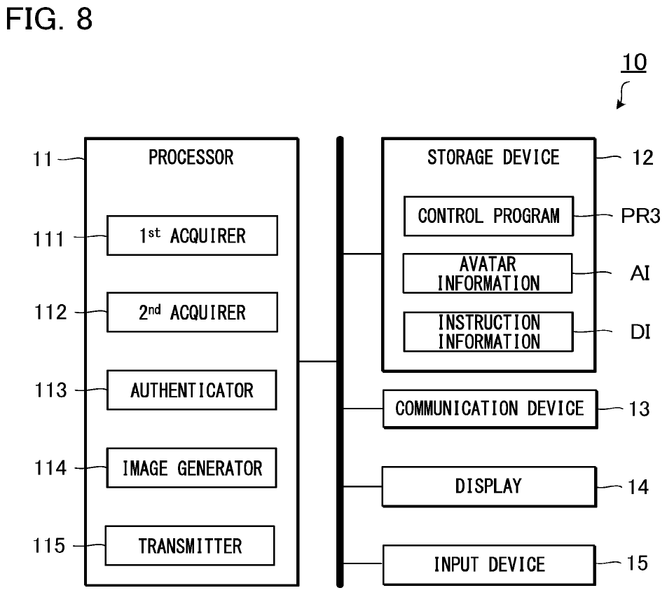

FIG. 8 is a block diagram illustrating an example of a configuration of the server 10. The server 10 includes a processor 11, a storage device 12, a communication device 13, a display 14, and an input device 15. Elements included in the server 10 are connected to each other by a single bus or by multiple buses for communication.

The processor 11 controls the entirety of the server 10. The processor 11 comprises one or more chips, such as a central processing unit (CPU) including an interface with a peripheral device, an arithmetic device, and a register. One, some, or all of the functions of the processor 11 may be implemented by hardware, such as a DSP, an ASIC, a PLD, or an FPGA. The processor 11 performs a variety of types of processing in parallel or sequentially.

The storage device 12 is a recording medium that is readable and writable by the processor 11. The storage device 12 stores programs including a control program PR3 executed by the processor 11. The storage device 12 stores avatar information AI and instruction information DI. The avatar information A1 is used for the image generator 114 (described later) to generate image information indicating a body image BP of the avatar A1. The instruct information DI is used to instruct the user U1 to move the head, and it is displayed on the MR glasses 30.

The communication device 13 is hardware serving as a transmission and reception device that communicates with another apparatus. The communication device 13 is also referred to as a network device, a network controller, a network card, and a communication module. The communication device 13 may include a connector for wired connection, and it may include an interface circuit that corresponds to the connector. The communication device 13 may include a wireless communication interface. Examples of the connector for wired connection and the interface circuit include products conforming to a wired LAN, IEEE 1394, and USB. Examples of the wireless communication interface include products conforming to a wireless LAN, and Bluetooth (registered trademark).

The display 14 is a device that displays an image and character information. The display 14 displays a variety of images under the control of the processor 11. As the display 14, a variety of display panels, such as a liquid crystal display panel or an organic EL display panel, are preferably used.

The input device 15 receives an operational input of an administrator of the information processing system 1. The input device 15 includes a pointing device, such as a keyboard, a touch pad, a touch panel, and a mouse.

If the input device 15 is a touch panel, the input device 15 may serve as the display 14.

For example, the processor 11 reads the control program PR3 from the storage device 12, and executes the control program PR3, to act as a first acquirer 111, a second acquirer 112, an authenticator 113, an image generator 114, and a transmitter 115.

The first acquirer 111 acquires from the terminal apparatus 20, a first image TP1 of the front face portion of the user U1. More specifically, the first acquirer 111 receives from the terminal apparatus 20 via the communication device 23, the first image TP1 of the front face portion of the user U1. The first image TP1 indicates the front face portion of the user U1 and is obtained by user inputs of the user U1 to the terminal apparatus 20 with the input device 25.

The second acquirer 112 acquires, from the terminal apparatus 20, a second image FP of the front face portion and the side face portion of the user U1. More specifically, the second acquirer 112 receives from the terminal apparatus 20 via the communication device 23, the second image FP of the front face portion and the side face portion of the user U1. The second image FP indicates the front face portion and the side face portion of the user U1. The second image FP is generated by the image generator 212 based on the image captured by the image capture device 26 included in the terminal apparatus 20 when the user U1 has moved the head.

The authenticator 113 authenticates the user U1 based on two images, the first image TP1 acquired by the first acquirer 111, and the second image FP acquired by the second acquirer 112. For example, to authenticate the user U1, the authenticator 113 generates a third image TP2 of the front face portion of the user U1 based on the second image FP, and collates the first image TP1 with the third image TP2. In collation by the authenticator 113, a technique of pattern matching is preferable. Specifically, the authenticator 113 compares the following (i) with (ii):
(i) characteristic data indicating characteristics of the face of the user U1 that have been extracted from the image information indicating the first image TP1, and
(ii) characteristic data indicating characteristics of the face of the user U1 that have been extracted from image information indicating the third image TP2.

As a result, when a degree of how much both the characteristic data match is greater than or equal to a predetermined threshold, the authenticator 113 authenticates the user U1.

The image generator 114 generates image information indicating an image to be displayed on the MR glasses 30. The image information is transmitted to the terminal apparatus 20 by the communication device 13. The transmitter 213 included in the terminal apparatus 20 outputs the image information to the MR glasses 30 such that the virtual object VO is to be shown in the virtual space VS based on the image information.

In particular, in the present embodiment, when the authenticator 113 has authenticated the user U1, the image generator 114 generates image information indicating a 3D image WP of the overall avatar A1 that corresponds to the user U1.

More specifically, the image generator 114 generates image information indicating the head image HP of the avatar A1, by using the second image FP acquired by the second acquirer 112. The image generator 114 may generate the image information indicating the head image HP of the avatar A1, by further using the first image TP1 acquired by the first acquirer 111. The image generator 114 generates the image information indicating the head image HP of the avatar A1, by not only using an image of the front face portion of the user U1 but also using an image of the side face portion of the user U1 included in the second image FP. This configuration enables the server 10 to make the head image HP of the avatar A1 more similar to the face of the user U1 in comparison with a case in which a 3D avatar A1 is generated by only using the image of the front face portion of the user U1. This configuration improves the quality of the head image HP of the avatar A1.

The image generator 114 generates image information indicating the body image BP of the avatar A1, by using the avatar information AI stored in the storage device 12. Finally, the image generator 114 generates image information indicating a 3D image WP of the overall avatar A1, by using the image information indicating the head image HP, and the image information indicating the body image BP, as illustrated in FIG. 7.

The transmitter 115 transmits the instruction information DI stored in the storage device 12 to the terminal apparatus 20 via the communication device 13. The instruction information DI is used to instruct the user U1 to move the head, and it is displayed on the MR glasses 30. The transmitter 115 transmits to the terminal apparatus 20 via the communication device 13, the image information that has been generated by the image generator 114 and indicates the 3D image WP of the overall avatar A1.

### 1-2: Operation of First Embodiment

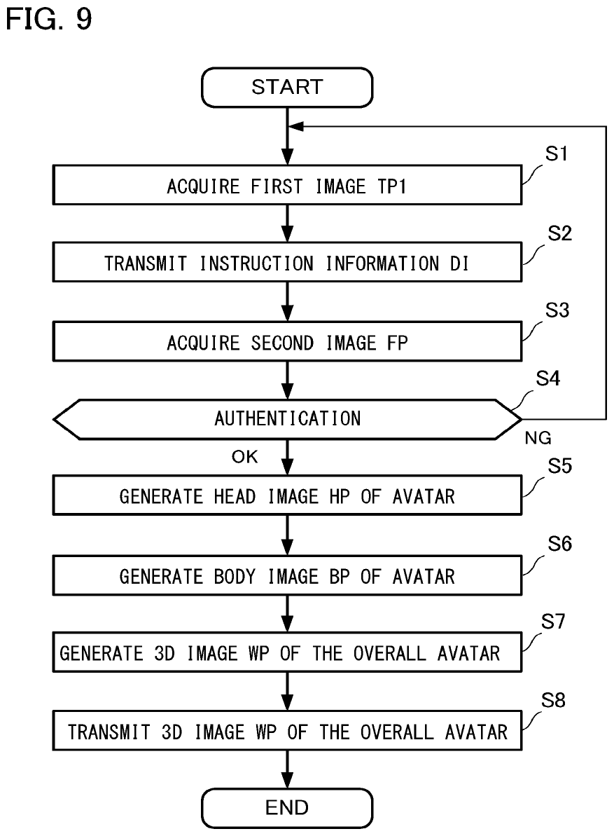

FIG. 9 is a flowchart illustrating an operation of the server 10 according to the first embodiment. The operation of the server 10 will be described below with reference to FIG. 9.

In Step S1, the processor 11 acts as the first acquirer 111. The processor 11 acquires from the terminal apparatus 20, a first image TP1 of a front face portion of the user U1.

In Step S2, the processor 11 acts as the transmitter 115. The processor 11 transmits the instruction information DI to the terminal apparatus 20 via the communication device 13. The instruction information DI is used to instruct the user U1 to move the head, and it is displayed on the MR glasses 30.

In Step S3, the processor 11 acts as the second acquirer 112. The processor 11 acquires from the terminal apparatus 20, a second image FP of the front face portion and the side face portion of the user U1.

In Step S4, the processor 11 acts as the authenticator 113. The processor 11 authenticates the user U1 based on the first image TP1 acquired by the first acquirer 111, and the second image FP acquired by the second acquirer 112. For example, to authenticate the user U1, the authenticator 113 generates a third image TP2 of the front face portion of the user U1 based on the second image FP, and collates the first image TP1 with the third image TP2. When the user U1 has been authenticated, that is, when a result of authentication in Step S4 is affirmative, the processor 11 executes Step S5. When the user U1 has not been authenticated, that is, when a result of authentication in Step S4 is negative, the processor 11 executes Step S1.

In Step S5, the processor 11 acts as the image generator 114. The processor 11 generates image information indicating a head image HP of the avatar A1, by using the second image FP acquired in Step S3.

In Step S6, the processor 11 acts as the image generator 114. The processor 11 generates image information indicating a body image BP of the avatar A1, by using the avatar information AI stored in the storage device 12.

In Step S7, the processor 11 acts as the image generator 114. The processor 11 generates image information indicating a 3D image WP of the overall avatar A1, by using the image information indicating the head image HP, and the image information indicating the body image BP.

In Step S8, the processor 11 acts as the transmitter 115. The processor 11 transmits to the terminal apparatus 20 via the communication device 13, the image information that has been generated in Step S7, and indicates the 3D image WP of the overall avatar A1. The processor 11 then terminates all of the processes illustrated in FIG. 9.

### 1-3: Effects Exhibited by First Embodiment

According to the foregoing description, the server 10 (serving as the avatar generation apparatus) includes the first acquirer 111, the second acquirer 112, the authenticator 113, and the image generator 114. The first acquirer 111 acquires a first image TP1 of the front face portion of the user U1. The second acquirer 112 acquires a second image FP of the front face portion and the side face portion of the user U1 in response to a motion of the head of the user U1. The authenticator 113 authenticates the user U1 based on the first image TP1 and the second image FP. The image generator 114 generates a head image HP of a 3D avatar of the user U1, by using the second image FP.

By employing the foregoing configuration, the server 10 generates a 3D avatar for which the identity of the user U1 has been verified. This processing enables the server 10 to avoid an act of impersonation. Furthermore, the second image FP of the face of the user U1 is acquired in response to the motion of the head of the user U1, and the server 10 generates a 3D avatar by using the second image FP. As a result, the quality of the 3D avatar is improved. Specifically, use of the motion of the head of the user U1 enables the server 10 to not only acquire an image of the front face portion of the user U1, but also to acquire an image of the side face portion. The server 10 generates the head image HP of the 3D avatar, by not only using an image of the front of the face, but also by using an image of the side face portion. This processing enables the server 10 to improve the quality of the 3D avatar.

According to the foregoing description, a third image TP2 of the front face portion of the user U1 is generated from the second image FP. The authenticator 113 authenticates the user U1 by collating the forementioned first image TP1 with the third image TP2.

By employing the foregoing configuration, the server 10 can authenticate the user U1 by using a technique of pattern patching, for example. This processing enables the server 10 to generate a 3D image WP of the avatar A1 of the user U1 who has been authenticated. This enables the server 10 to prevent another user U from performing an act of impersonation.

The server 10 generates a head image HP of the 3D avatar, not only by using an image of the front face portion, but also by using an image of the side face portion. If the server 10 verifies the identity of the user U1 in generating the head image HP, a method is suggested in which each of two images, an image of the front face portion and an image of the side face portion, are used to verify the identity of the user U1. However, in the present embodiment, only the image of the front face portion is used to verify the user's identity. In acquiring an image of the side face portion, the server 10 performs identity verification based on a degree of how much a motion of the head of the user U1 matches a motion indicated by the instruction information DI. The server 10 does not perform identity verification processing on the image itself of the side face portion. Accordingly, processing of identity verification according to the present embodiment imposes a light load on the server 10 in comparison with processing by performing identity verification on each of the two images, an image of the front face portion and an image of the side face portion.

According to the foregoing description, the second acquirer 112 acquires the second image FP based on a video of the motion of the user U1's head.

By employing the foregoing configuration, the server 10 can use a high-quality image of the side face portion of the user U1 in comparison with use of still images obtained by imaging the motion of the head of the user UI. This processing enables the server 10 to generate a head image HP with high quality of the avatar A1 serving as a 3D avatar.

### 2: Second Embodiment

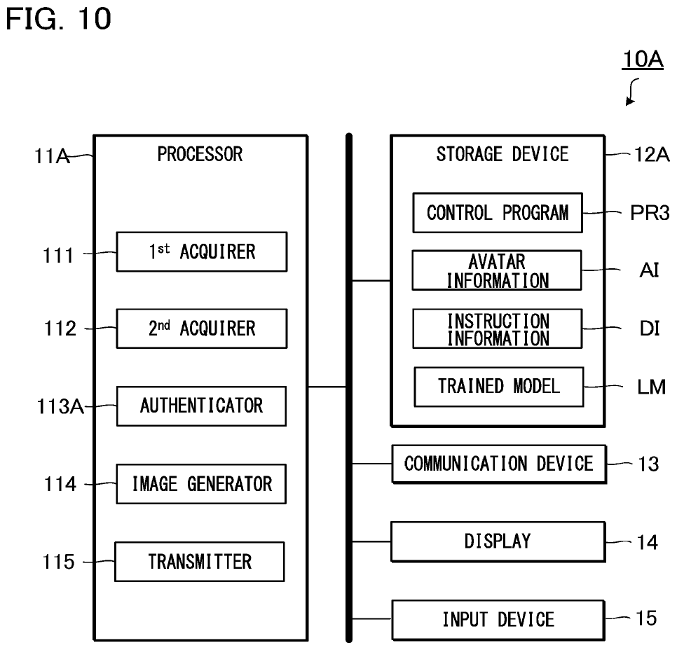

With reference to FIG. 10, description will be given of a configuration of an information processing system 1A including a server 10A. The server 10A serves as an avatar generation apparatus according to a second embodiment of the present invention. In the description below, for simplification thereof, from among components included in the information processing system 1A according to the second embodiment, components identical to those included in the information processing system 1 according to the first embodiment are denoted by identical reference signs, and the description thereof is omitted in some cases.

### 2-1: Configuration of Second Embodiment

### 2-1-1: Overall Configuration

The information processing system 1A according to the second embodiment of the present invention differs from the information processing system 1 according to the first embodiment in that the server 10A is included instead of the server 10. In the other matters, the overall configuration of the information processing system 1A is identical to that of the information processing system 1 according to the first embodiment illustrated in FIG. 1, and therefore, illustration and description thereof are omitted.

### 2-1-2: Configuration of Server

FIG. 10 is a block diagram illustrating an example of a configuration of the server 10A. In contrast to the server 10, the server 10A includes a processor 11A instead of the processor 11, and a storage device 12A instead of the storage device 12.

The storage device 12A stores a trained model LM in addition to the control program PR3, the avatar information AI, and the instruction information DI.

The trained model LM is used to authenticate the user U1 by an authenticator 113A (described later), based on the second image FP of the front face portion and the side face portion of the user U1, which is acquired by the second acquirer 112.

The trained model LM is generated by learning training data in a training phase. The training data used to generate the trained model LM includes two or more pairs of first characteristic information and an authentication result of each person. The first characteristic information is extracted from a first image TP1 of the face of each person, which is acquired by the first acquirer 111.

The trained model LM is generated outside the server 10. In particular, it is preferable that the trained model LM be generated in a second server (not shown). In this case, the server 10 acquires the trained model LM from the second server (not shown) via the communication network NET.

The processor 11A includes the authenticator 113A instead of the authenticator 113 included in the processor 11.

The authenticator 113A authenticates the user U1 by inputting second characteristic information to the trained model LM. The second characteristic information indicates characteristics extracted from the second image FP of the front face portion and the side face portion of the user U1. The second image FP is an image acquired by the second acquirer 112.

### 2-2: Operation of Second Embodiment

In contrast to the server 10 according to the first embodiment, the processor 11A included in the server 10A according to the second embodiment acts as the authenticator 113A in the forementioned Step S4. The processor 11A authenticates the user U1 by inputting the second characteristic information to the trained model LM. The second characteristic information indicates characteristics extracted from the second image FP of the front face portion and the side face portion of the user U1. The second image FP is an image acquired by the second acquirer 112. Processes performed by the server 10A in the other steps are identical to these performed by the server 10, and therefore the illustration of a flowchart illustrating an operation of the server 10A is omitted.

### 2-3: Effects Exhibited by Second Embodiment

According to the foregoing description, in the server 10A serving as the avatar generation apparatus, the authenticator 113A authenticates the user U1 by inputting to the trained model LM, the second characteristic information indicating characteristics extracted from the second image FP. The trained model LM has learned a relationship between (i) the first characteristic information indicating characteristics extracted from the first image TP1 of the face of each person, and (ii) an authentication result of each person.

By employing the foregoing configuration, the server 10A can authenticate the user U1 by using machine learning. This processing enables the server 10A to generate a 3D image WP of the avatar A1 that corresponds to the user U1 who has been authenticated. This enables the server 10A to prevent another user U from performing an act of impersonation.

### 3: Third Embodiment

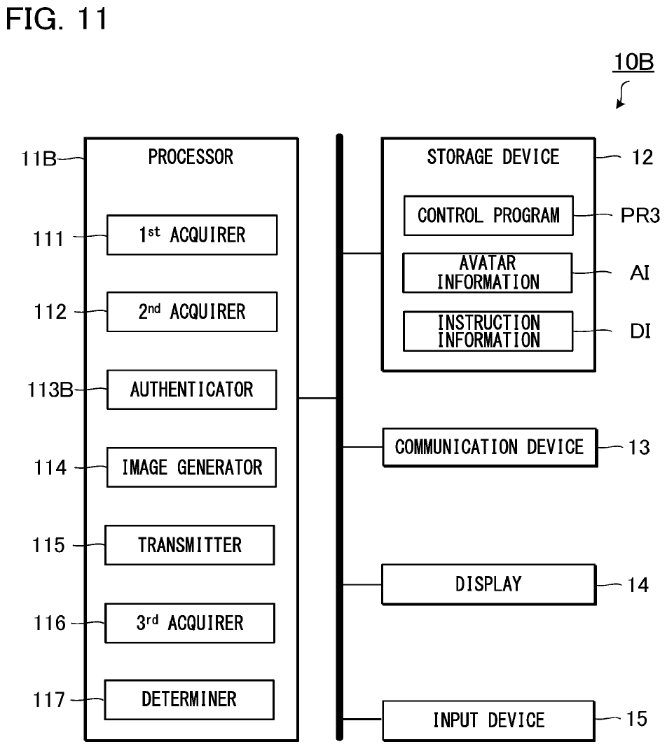

With reference to FIG. 11, description will be given of a configuration of an information processing system 1B including a server 10B. The server 10B serves as an avatar generation apparatus according to a third embodiment of the present invention. In the description below, for simplification of description, from among components included in the information processing system 1B according to the third embodiment, components identical to those included in the information processing system 1 according to the first embodiment are denoted by identical reference signs, and description thereof is omitted in some cases.

### 3-1: Configuration of Third Embodiment

### 3-1-1: Overall Configuration

The information processing system 1B according to the third embodiment of the present invention differs from the information processing system 1 according to the first embodiment in that the server 10B is included instead of the server 10. In the other matters, the overall configuration of the information processing system 1B is identical to that of the information processing system 1 according to the first embodiment illustrated in FIG. 1, and therefore, illustration and description thereof are omitted.

### 3-1-2: Configuration of Server

FIG. 11 is a block diagram illustrating an example of a configuration of the server 10B. In contrast to the server 10, the server 10B includes a processor 11B instead of the processor 11.

The processor 11B includes an authenticator 113B instead of the authenticator 113 included in the processor 11. The processor 11B further includes a third acquirer 116 and a determiner 117.

The third acquirer 116 acquires from the terminal apparatus 20 via the communication device 13, the motion information relating to a motion of the MR glasses 30. The third acquirer 116 computes movement information relating to a motion of the head of the user U1 based on the acquired motion information, and outputs the movement information to the determiner 117.

The determiner 117 determines whether a value indicating a degree of how much the following (i) and (ii) match is greater than or equal to a predetermined value:
(i) a motion instructed by the instruction information DI, in which the instruction information DI is used to instruct the user U1 to move the head and is output to the terminal apparatus 20 via the transmitter 115, and
(ii) a motion of the head of the user U1 indicated by the movement information.

In substantially the same manner as an authentication method according to the first embodiment, the authenticator 113B compares the following (i) with (ii):
(i) characteristic data indicating characteristics of the face of the user U1 that have been extracted from image information indicating the first image TP1, and
(ii) characteristic data indicating characteristics of the face of the user U1 that have been extracted from image information indicating the third image TP2.

When a degree of how much both match is greater than or equal to a predetermined threshold, and when a result of determination performed by the determiner 117 is affirmative, the authenticator 113B authenticates the user U1.

### 3-2: Operation of Third Embodiment

In contrast to the server 10 according to the first embodiment, the processor 11B included in the server 10B according to the third embodiment acts as the determiner 117 in the forementioned Step S4. The processor 11B determines whether a value indicating a degree of how much the following (i) and (ii) match is greater than or equal to a predetermined value:
(i) a motion instructed by instruction information DI, in which the instruction information DI is used to instruct the user U1 to move the head and is shown on the MR glasses 30, and
(ii) a motion of the head of the user U1 that is indicated by the motion information.

Furthermore, the processor 11B acts as the authenticator 113B. When a result of determination, which is obtained by implementing a function of the determiner 117, is affirmative, the processor 11B authenticates the user U1. On the other hand, when a result of determination, which is obtained by implementing a function of the determiner 117, is negative, the processor 11B does not authenticate the user U1. Process performed by the server 10B in the other steps are identical to those performed by the server 10, and therefore, the illustration of a flowchart illustrating an operation of the server 10B is omitted.

### 3-3: Effects Exhibited by Third Embodiment

According to the foregoing description, the server 10B serving as an avatar generation apparatus includes the transmitter 115 and the determiner 117. The transmitter 115 outputs instruction information DI, which is used to instruct the user U1 to move the head and is shown on the MR glasses 30 serving as a display apparatus. The determiner 117 determines whether a value indicating a degree of how much a motion of the head of the user U1 matches a motion instructed by the instruction information DI is greater than or equal to the predetermined value. The authenticator 113B performs authentication that is substantially the same as that performed by the authenticator 113 according to the first embodiment. The authenticator 113B authenticates the user U1 when a result of determination performed by the determiner 117 is affirmative.

By employing the foregoing configuration, the server 10B can authenticate the user U1 based on a motion itself of the head of the user U1. This processing enables the server 10B to generate a 3D image WP of the avatar A1 that corresponds to the user U1 who has been authenticated. This enables the server 10B to prevent another user U from performing an act of impersonation.

### 4: Modifications

The present disclosure is not limited to the examples of the foregoing embodiments. Specific modified aspects will be described below. Two or more aspects freely selected from the description below may be combined.

### 4-1: First Modification

The terminal apparatus 20 according to the foregoing embodiments includes the image generator 212. The image generator 212 generates a second image FP of the front face portion and the side face portion of the user U1 based on an image of the head of the user U1 captured by the image capture device 26 when the user U1 has moved the head. However, the operation may be performed by an apparatus other than the terminal apparatus 20. For example, the servers 10 through 10B may include an image generator that is substantially the same as the image generator 212, and they may generate the second image FP of the front face portion and the side face portion of the user U1. For example, the image generator 114 included in the servers 10 through 10B may also have a function of the image generator 212, and therefore, the servers 10 through 10B may generate the second image FP of the front face portion and the side face portion of the user U1.

### 4-2: Second Modification

In the information processing system 1 to the information processing system 1B according to the foregoing embodiments, the terminal apparatus 20 and the MR glasses 30 are different entities. However, a method for implementing the terminal apparatus 20 and the MR glasses 30 in embodiments of the present invention is not limited thereto. For example, the MR glasses 30 may have a function identical to that of the terminal apparatus 20, and therefore the terminal apparatus 20 and the MR glasses 30 may be a single entity.

### 4-3: Third Modification

The information processing system 1 to the information processing system 1B according to the foregoing embodiments include the MR glasses 30. However, instead of the MR glasses 30, the information processing system 1 to the information processing system 1B may include any one of an HMD that has employed the virtual reality (VR) technology, an HMD that has employed the augmented reality (AR) technology, and AR glasses that have employed the AR technology. Alternatively, instead of the MR glasses 30, the information processing system 1 to the information processing system 1B may include any one of a smartphone with an image capture device, and a normal tablet with an image capture device. The HMD, the AR glasses, the smartphone, and the tablet are examples of the display apparatus.

### 5: Other Matters

(1) In the foregoing embodiments, as examples of the storage device 12, the storage device 22, and the storage device 32, a ROM, a RAM, and the like have been described. However, the storage device 12, the storage device 22, and the storage device 32 are a flexible disk, a magneto-optical disk (for example, a compact disc, a digital versatile disc, or a Blu-ray (registered trademark) disc), a smart card, a flash memory device (for example, a card, a stick, or a key drive), a compact disc-ROM (CD-ROM), a register, a removable disk, a hard disk, a floppy (registered trademark) disk, a magnetic strip, a database, a server, or another appropriate storage medium. The programs may be transmitted from a network via an electric communication line. The programs may be transmitted from the communication network NET via the electric communication line.

(2) In the foregoing embodiments, the information, signal, or the like may be expressed by using any of various different techniques. For example, data, an order, a command, information, a signal, a bit, a symbol, a chip, or the like that can be referred to throughout the description above may be expressed by using a voltage, a current, electromagnetic waves, a magnetic field or a magnetic particle, a photo field or a photon, or any combination thereof.

(3) In the foregoing embodiments, information or the like that has been input or output may be stored in a specified place (for example, a memory), or may be managed by using a management table. The information or the like that has been input or output can undergo overwriting, updating, or postscript. The information or the like that has been output may be deleted. The information or the like that has been input may be transmitted to another apparatus.

(4) In the foregoing embodiments, determination may be performed on the basis of a value (0 or 1) expressed by using one bit, may be performed on the basis of a Boolean value (true or false), or may be performed on the basis of a comparison between numerical values (for example, a comparison with a predetermined value).

(5) In a processing procedure, a sequence, a flowchart, or the like that has been described as an example in the embodiments described above, the order may be changed without inconsistency. For example, in the method described in the present disclosure, various step elements have been provided by using an illustrative order, and the specified order that has been provided is not restrictive.

(6) The respective functions illustrated in FIGS. 1 to 11 are implemented by any combination of at least one of hardware and software. A method for implementing respective function blocks is not particularly limited. Stated another way, the respective function blocks may be implemented by using a single physically or logically coupled device, or may be implemented by directly or indirectly (for example, in a wired manner, in a wireless manner, or the like) connecting two or more devices that are physically or logically separated, and using these plural devices. The function blocks may be implemented by a combination of the single device described above or the plural devices described above and software.

(7) The foregoing programs as an example in the embodiments described above are to be broadly construed as meaning of an order, an order set, a code, a code segment, a program code, a program, a sub-program, a software module, an application, a software application, a software package, a routine, a sub-routine, an object, an executable file, an execution thread, a procedure, a function, or the like, regardless of whether the programs are referred to as software, firmware, middleware, a microcode, a hardware description language, or another term.

Software, an order, information, or the like may be transmitted or received via a transmission medium. For example, when software is transmitted from a website, a server, or another remote source by using at least one of a wired technique (a coaxial cable, an optical fiber cable, a twisted-pair wire, a digital subscriber line (DSL), or the like) or a wireless technique (infrared rays, microwaves, or the like), at least one of these wired and wireless techniques falls under the definition of the transmission medium.

(8) In each of the embodiments described above, the terms “system” and “network” are compatibly used.

(9) The information, the parameter, or the like that has been described in the present disclosure may be expressed by using an absolute value, may be expressed by using a value relative to a predetermined value, or may be expressed by using other corresponding information.

(10) In the foregoing embodiments, the server 10 to the server 10B and the terminal apparatus 20 are a mobile station (MS) in some cases. In some cases, the mobile station is referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms by those skilled in the art. In the present disclosure, the terms “mobile station”, “user terminal”, “user equipment (UE)”, “terminal”, and the like can be compatibly used.

(11) In the foregoing embodiments, the terms “connected”, and “coupled”, or all transformations thereof mean all types of direct or indirect connection or coupling of two or more elements, and include that one or more intermediate elements exist between two elements that are “connected” or “coupled” to each other. Coupling or connection of elements may be physical coupling or connection, logical coupling or connection, or a combination thereof. For example, “connection” may be replaced with “access”. In the case of use in the present disclosure, it can be considered that two elements are “connected” or “coupled” to each other by using at least one of one or more electric wires, cables, and printed electric connection, and by using electromagnetic energy or the like having wavelengths of, as some non-limiting and non-comprehensive examples, a wireless frequency range, a microwave region, and a light (both visible and invisible) region.

(12) In the forgoing embodiments, the description “on the basis of” does not mean “solely on the basis of” unless otherwise specified. In other words, the description “on the basis of” means both “solely on the basis of” and “at least on the basis of”.

(13) The term “determining” used in the present disclosure includes a variety of operations in some cases. The “determining” can include, for example, that “judging”, “calculating”, “computing”, “processing”, “deriving”, “investigating”, “looking up, search, or inquiry” (for example, looking up, search, or inquiry of a table, a database, or another data structure), ascertaining is considered as “determining”. The term “determining” can include, for example, that “receiving” (for example, receiving information), “transmitting” (for example, transmitting information), “input”, “output”, or “accessing” (for example, accessing data in a memory) is considered as “determining”. The term “determining” can include that “resolving”, “selecting”, “choosing”, “establishing”, “comparing”, or the like is considered as “determining”. Stated another way, “determining” can include that any kind of operation is considered as “determining”. The term “determining” may be replaced with “assuming”, “expecting”, “considering”, or the like.

(14) In the embodiments described above, in a case where “include”, “including”, and the transformation thereof are used, these terms are intended to be comprehensive in substantially the same manner as the term “comprising”. The term “or” used in the present disclosure is intended to not be exclusive OR.

(15) In the present disclosure, for example, in a case where an article, such as a, an, or the, is added, the present disclosure may include that nouns that follow these articles are plural.

(16) In the present disclosure, the description “A and B are different” may mean “A and B are different from each other”. The description may mean “each of A and B is different from C”. The terms “separated”, “coupled”, and the like may be construed in substantially the same manner as “different”.

(17) Respective aspects and embodiments described in the present disclosure may be used individually, may be combined and used, or may be switched and used according to execution. A report of predetermined information (for example, a report of “X”) is not limited to a report that is explicitly made, and may be implicitly made (for example, without making a report of the predetermined information).

The present disclosure has been described in detail above, but it would be obvious to those skilled in the art that the present disclosure is not limited to the embodiments described in the present disclosure. The present disclosure can be implemented as alterations and modifications without departing from the spirit and scope of the present disclosure specified by the description of the claims. Accordingly, the description of the present disclosure has been provided for exemplary and explanatory purposes, and is not restrictive of the present disclosure.

### DESCRIPTION OF REFERENCE SIGNS

1, 1A, 1B . . . information processing system, 10, 10A, 10B . . . server, 11, 11A, 11B . . . processor, 12, 12A . . . storage device, 13 . . . communication device, 14 . . . display, 15 . . . input device, 16 . . . image capture device, 20 . . . terminal apparatus, 21 . . . processor, 22 . . . storage device, 23 . . . communication device, 24 . . . display, 25 . . . input device, 26 . . . image capture device, 30 . . . MR glasses, 31 . . . processor, 32 . . . storage device, 33 . . . line-of-sight detection device, 34 . . . GPS device, 35 . . . motion detection device, 36 . . . image capture device, 37 . . . communication device, 38 . . . display, 41L, 41R . . . lens, 91, 92 . . . temple, 93 . . . bridge, 94, 95 . . . frame, 111 . . . first acquirer, 112 . . . second acquirer, 113, 113A, 113B . . . authenticator, 114 image generator, 115 . . . transmitter, 116 . . . third acquirer, 117 . . . determiner, 211 . . . acquirer, 212 . . . image generator, 213 . . . transmitter, 311 . . . acquirer, 312 . . . display controller, A1, A2 . . . avatar, PR1, PR2, PR3 . . . control program, TI1, TI2 . . . image information, TP1 . . . first 2D image, TP2 . . . second 2D image, U1, U2 . . . User, and VO, VO1 to VO5 . . . virtual object.

1. An avatar generation apparatus comprising:
a first acquirer configured to acquire a first image indicating a front face portion of a user;
a second acquirer configured to acquire, in response to a motion of the head of the user, a second image indicating the front face portion and a side face portion of the user;
an authenticator configured to authenticate the user based on the first and second images; and
an image generator configured to generate a head image of a three-dimensional avatar of the user, by using the second image.

2. The avatar generation apparatus according to claim 1,
wherein the authenticator is configured to authenticate the user by collating the first image with a third image, and the third image is an image that indicates the front face portion of the user and that is generated from the second image.

3. The avatar generation apparatus according to claim 1, wherein:
the authenticator is configured to authenticate the user by inputting to a trained model that has learned a relationship between first characteristic information and an authentication result, second characteristic information,
the first characteristic information indicates characteristics that have been extracted from the first image indicating a front face portion of each of a plurality of persons,
the authentication result is a result of each of the plurality of persons, and
the second characteristic information indicates characteristics that have been extracted from the second image.

4. The avatar generation apparatus according to any one of claims 1 to 3, further comprising:
a transmitter configured to output instruction information for causing a display apparatus to display instructions to move the head of the user; and
a determiner configured to determine whether a value is greater than or equal to a predetermined value, the value indicating a degree of how much the motion of the head of the user matches a motion instructed by the instruction information,
wherein the authenticator is configured to further authenticate the user, when a result of determination performed by the determiner is affirmative.

5. The avatar generation apparatus according to any one of claims 1 to 4,
wherein the second acquirer is configured to acquire the three-dimensional image based on a video obtained by imaging the motion of the head of the user.
